(19) United States
(12) Patent Application Publication
(10) Pub. No.: US 2026/0065142 A1
(43) Pub. Date: Mar. 5, 2026

(54) AUTOMATED MACHINE LEARNING MODEL GENERATION USING CORRELATION BETWEEN ATTRIBUTES

(71) Applicant: International Business Machines Corporation, Armonk, NY (US)

(72) Inventors: Ruchi Mahindru, Elmsford, NY (US); Harshit Kumar, Gurgaon (IN); Gargi Banerjee Dasgupta, Bangalore (IN)

(21) Appl. No.: 18/825,912

(22) Filed: Sep. 5, 2024

(51) Int. Cl. G06N 20/00

(52) U.S. Cl. CPC G06N 20/00

(57) ABSTRACT

An example operation may include one or more of accessing table data including columns corresponding to candidate attributes, respectively, and a target column corresponding to a target attribute, determining, by executing an entropy function, entropy values of the candidate attributes based on randomness of values in the columns, respectively, identifying a subset of candidate attributes that have entropy values between a predefined range of entropy values, determining a correlation between the subset of attributes by executing a correlation function on values in columns, determining at least one machine learning (ML) model to be generated based on the correlation between the subset of candidate attributes, and training the at least one ML model to determine the target attribute based on execution of the at least one ML model on training data to generate a trained at least one ML model.

### BACKGROUND

Historical data sets are leveraged to train predictive models (e.g., artificial intelligence, machine learning, etc.) to perform Artificial Intelligence for IT Operations (AIOps) tasks such as anomaly detection, fault localization, resolution retrieval, and many others. The historical data sets may include messages from logs, tickets, resolutions, and the like. The historical data sets often include many attributes, but a given task may only need/rely on a few of these attributes.

### SUMMARY

One example embodiment provides a computer-implemented method that may include accessing table data within a database, the table data that includes columns corresponding to candidate attributes, respectively, and a target column corresponding to a target attribute. The computer-implemented method may include determining, by executing an entropy function, entropy values of the candidate attributes based on randomness of values in the columns corresponding to the candidate attributes, respectively. The computer-implemented method may include identifying a subset of candidate attributes among the candidate attributes that have entropy values between a predefined range of entropy values. The computer-implemented method may include determining a correlation between the subset of attributes by executing a correlation function on values in columns corresponding to the subset of candidate attributes. The computer-implemented method may include determining at least one machine learning (ML) model to be generated based on the correlation between the subset of candidate attributes. The computer-implemented method may include training the at least one ML model to determine the target attribute based on execution of the at least one ML model on training data to generate a trained at least one ML model.

Another example embodiment provides a computer system that may include a processor set, a set of one or more computer-readable storage media, and program instructions, collectively stored in the set of one or more storage media, for causing the processor set to perform computer operations that may include accessing table data within a database, the table data that includes columns corresponding to candidate attributes, respectively, and a target column corresponding to a target attribute. The computer operations may include determining, by executing an entropy function, entropy values of the candidate attributes based on randomness of values in the columns corresponding to the candidate attributes, respectively. The computer operations may include identifying a subset of candidate attributes among the candidate attributes that have entropy values between a predefined range of entropy values. The computer operations may include determining a correlation between the subset of attributes by executing a correlation function on values in columns corresponding to the subset of candidate attributes. The computer operations may include determining at least one machine learning (ML) model to be generated based on the correlation between the subset of candidate attributes. The computer operations may include training the at least one ML model to determine the target attribute based on execution of the at least one ML model on training data to generate a trained at least one ML model.

A further example embodiment provides a computer program product that may include a set of one or more computer-readable storage media, and program instructions, collectively stored in the set of one or more computer-readable storage media, for causing a processor set to perform computer operations that may include accessing table data within a database, the table data that includes columns corresponding to candidate attributes, respectively, and a target column corresponding to a target attribute. The computer operations may include determining, by executing an entropy function, entropy values of the candidate attributes based on randomness of values in the columns corresponding to the candidate attributes, respectively. The computer operations may include identifying a subset of candidate attributes among the candidate attributes that have entropy values between a predefined range of entropy values. The computer operations may include determining a correlation between the subset of attributes by executing a correlation function on values in columns corresponding to the subset of candidate attributes. The computer operations may include determining at least one machine learning (ML) model to be generated based on the correlation between the subset of candidate attributes. The computer operations may include training the at least one ML model to determine the target attribute based on execution of the at least one ML model on training data to generate a trained at least one ML model.

### BRIEF DESCRIPTION OF THE DRAWINGS

FIG. 1 is a diagram illustrating a computing environment according to an embodiment of the instant solution.

FIG. 2A is a diagram illustrating a process of identifying relevant candidate attributes that need predictive models from raw data according to the examples and features of the instant solution.

FIG. 2B is a diagram illustrating a process of training ML models for predicting the relevant candidate attributes according to the examples and features of the instant solution.

FIG. 2C is a diagram illustrating a process of training a ML model to determine target attribute based on relevant candidate attributes according to the examples and features of the instant solution.

FIG. 2D is a diagram illustrating an example of a sequence of models that can be generated according to the examples and features of the instant solution.

FIG. 3A is a diagram illustrating an example of attribute data stored in a table according to the examples and features of the instant solution.

FIG. 3B is a diagram illustrating a process of identifying attributes for model generation from the attribute data in FIG. 3A, according to the examples and features of the instant solution.

FIG. 4 is a diagram illustrating a process of executing a trained sequence of models to predict and target attribute and receiving feedback about the predicted output according to examples and features of the instant solution.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

FIG. 6A illustrates a flow diagram, according to example embodiments.

FIG. 6B illustrates a flow diagram, according to example embodiments.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

According to an aspect of the example embodiments, there is provided a system that can recognize a subset of attributes for training a machine learning (ML) model to perform a given task from a larger set of attributes, identify a relationship between the subset of attributes with respect to a target attribute, determine a sequence of models to be trained to predict the target attribute, and train the ML model. The process can be performed without a need for a human (i.e., without a need for a subject matter expert) to identify the relevant attributes or determine which attributes will need to be determined using predictive models. Rather, the services described herein may automatically identify relevant attributes with respect to a target attribute (i.e., an attribute to be predicted), and may identify a relationship between the attributes. Furthermore, the system may determine a sequence of ML models that can be used to predict the target attribute including one or more intervening models which infer attributes from attributes that are expressly provided in the input data. Furthermore, the system can provide a graphical user interface (GUI) that enables a user to provide model types, training data for training the models, feedback, and the like.

When building an AI/ML prediction model for a downstream task, attributes (extractable and manually annotated) are used. These attributes may include data from a log file, data from information technology (IT) tickets, data from human-generated notes, and the like. However, not all attributes are necessary for performing a given predictive task. Identifying which attributes are relevant for the given AIOps task is important for building accurate models. Furthermore, when building these models, it is not feasible to ask a human to manually provide the attribute values given that humans may have a difficult time determining which values are most useful for such a predictive task without significant trial and error. Even in the case of a subject matter expert, the subject matter expert provides a guess as to which attributes they believe are relevant. To address these issues, the example embodiments are directed to an end-to-end system that performs 1) task specific selection of candidate attributes and relationship derivation from multi-modal IT Operations data for an AIOps pipeline using multi-modal input data and 2) learns and generates insights for improvement.

Predictive AIOps tasks include issue resolution, anomaly detection, fault localization, root cause analysis, performance monitoring, capacity optimization, event correlation, and the like. Artificial intelligence models for performing each of these tasks require a different subset of attributes for accurate model training. According to various embodiments, for a given AIOps task with a target attribute, the system described herein may identify the most relevant subset of attributes for building an artificial intelligence (AI)/machine learning (ML) model for that task. As an example, a target task may be to identify a resolution for an issue provided in a ticket submitted to an information technology system. In this case, the target attribute may be a location of the resolution such as a URL, etc. Here, the system can identify related attributes (e.g., message code, error code, category, severity, etc.) that are related to the target attribute (e.g., URL of resolution), and determine the models that are necessary for both obtaining the related attributes and for predicting the target attribute from the related attribute.

As a more generic example, task A for predicting a target attribute T may require three extractable attributes a1, a2, and a3, which can be extracted directly from the historical data set, and two additional attributes p1 and p2 which can be predicted from the extractable attributes. In this case, the system may determine that predictive models are needed for predicting attributes p1 and p2, respectively. In addition, a third model is needed for predicting the target attribute T. As new tasks arrive, automatically identifying relevant attributes is helpful for building an AI/ML model for the newly arrived task. The system may use entropy computation and correlation to find the most relevant attributes with respect to a target attribute by executing an entropy computation and a correlation computation, respectively. Entropy calculations and correlation calculations may be performed using known software libraries. For example, a Python library SciPy may be used to determine the randomness within a column of data (i.e., entropy). In addition, SciPy may also be used to determine a correlation between attributes, for example, using Pearson's correlation or the like.

According to various embodiments, after identifying the relevant subset of attributes, the system may identify the interdependence (i.e., the relationship(s)) between the subset of attributes for the given task. Since each task requires a different set of attributes, one of the challenges is to identify an interdependency among the attributes. Interdependency among the attributes is important for predicting the values of the task. Identifying attribute dependency is especially relevant for AIOps, where log data contains information that experts often manually annotate providing annotations. An attribute may need a different prediction algorithm for a task as opposed to others.

For example, assume task A includes three extractable attributes a1, a2, a3, and a predictable attribute p4. Here, p4 may have a correlation with a1. For example, p4 may be conditional upon a1. A conditional relationship exists when a value of p4 depends on a value for a1. As another example, a hierarchical relationship may exist between p4 and a1. As an example, a hierarchical relationship exists when a1 is a make of an automobile, and p4 is a model of the automobile. In this case, you need the make to determine which models are available. In the example embodiments, the system can detect conditional relationships and hierarchical relationships amongst the extractable attributes and the predictable attributes, and use these relationships to generate predictive models for predicting the attribute value such as p4 from the known value a1. The predictive models may be in addition to the model that is generated for determining the target attribute. In this case, the target attribute determination relies on the value of p4 that is predicted using the predictive model. Thus, a sequence of models can be created and stitched together to arrive at a final sequence of models for performing a given task, such as issue resolution.

In some embodiments, the system may include a database of training data with historical data sets. The database may be referred to as a domain knowledge policy and relationship database. A data analysis and/or a subject matter expert may define metadata relevant for various components in the AIOps pipeline. During attribute identification, metadata may be extracted from identified datasets (such as ticket data, forum data, etc.) to build a knowledge base to store the metadata. Here, the system may identify candidate contextual attributes using an entropy-based approach. In these examples, attributes refer to columns in a table of data. The entropy of each attribute may be determined based on a randomness of the values in a corresponding column of data corresponding to the attribute. Entropy values may range from zero (0) to log2n where n represents a number of possible outcomes. In this case, the system may be searching for entropy values that are within a specific range (e.g., between 1 and 9, etc.) for selection as relevant attributes. Furthermore, the system may also determine a correlation between the relevant attributes and the target attribute and use the correlation to further remove one or more of the relevant attributes.

For example, the entropy calculation may be performed using a function within a software library that can be applied to each attribute in the data set. Here, one or more of entropy, information gain, and the like may be determined for each of the attributes, and these values can be used to select the relevant subset of attributes. Entropy captures the randomness in the state of a metadata attribute where high randomness implies low information gain. In this case, attributes with lower entropy indicate more randomness which is preferred for model training.

According to various embodiments, after identifying the subset of relevant attributes, the system may compute a correlation between the relevant attributes and the target attribute using a predefined correlation algorithm. The correlation captures the relationship between the target attribute (identified based on the policy or data analysis) and the subset of relevant attributes. For example, attributes that highly correlate with the services impacted are useful for fault localization, attributes that highly correlate with the message code are useful for anomaly detection, attributes that highly correlate with the resolution URL are useful for resolution retrieval, and the like. Meanwhile, relevant attributes that are not highly correlated with the target attribute may be discarded and not used for model development.

There are three types of relationships that can be determined between attributes based on the correlation computation. For example, an independent relationship may be determined. Here, the independent relationship may be identified when the system computes a zero correlation between the contextual attributes. In this case, the zero correlation means that their relationship is independent. As another example, a conditional relationship may be determined when the system. For example, the system computing a positive or negative correlation means that a conditional based model can be recommended by the system and can be trained with the model being generated for the given task. As another example, a subsumptive relationship can be identified from the correlation.

In the example embodiments, the system may receive a task such as a model and a target attribute to be predicted by the mode. In response, the system may identify candidate attributes from a pool of attributes including attributes that are directly extractable from input data and attributes that can be derived (e.g., predicted, etc.) from the extractable attributes. The system may identify task-dependent dynamic relationships between candidate attributes to determine a type of the relationships (e.g., independent, conditional, or hierarchical) for output prediction. The system can provide clear explainability for the results derived to enable human comprehension and active feedback collection that can be incorporated into the system for improvements.

In some embodiments, the system may perform task specific optimal context derivation from multi-modal data such as log data, ticket data, resolution data, etc. from AIOps operations. The system may use the multi-model data for modeling downstream tasks. Examples of downstream tasks include selecting contextual attributes from the candidate attribute set in relation to the task specific target attribute, where attributes are extracted from siloed and heterogeneous multi-modal IT operations data to curate a knowledge base consisting of candidate attributes. As another example, the downstream task may include deriving relationship types between the selected contextual attributes, where for a given task, attributes may have different relationship namely independent, conditional, or hierarchical. As another example, downstream tasks may include exploiting knowledge of relationship between attributes, for modeling downstream tasks like context prediction model, query formulation, and explainability. As another example, the downstream tasks may include training and improving at least one model to discover a target attribute from raw input data, using the relationships. The training and retraining processes may include a human-in-the-loop.

The system described herein may be hosted within a software application, a service, or the like, which may be hosted by a host platform such as a cloud platform, a web server, a database, or the like.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure, including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer can deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community with shared concerns (e.g., mission, security requirements, policy, and compliance considerations). It may be managed by organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

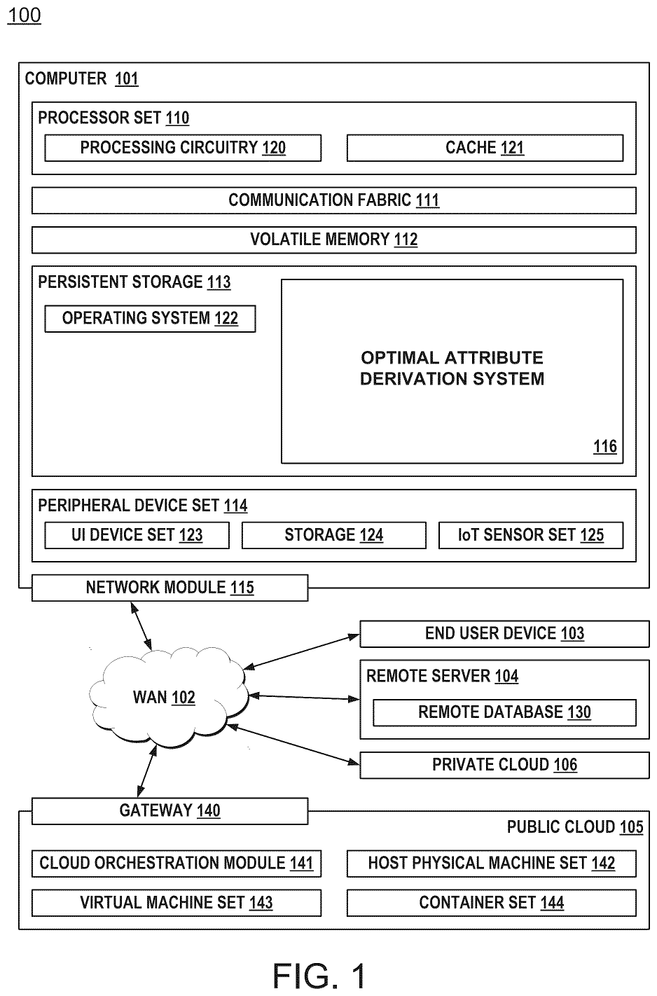

FIG. 1 illustrates a computing environment 100 according to an embodiment of the instant solution. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 1, computing environment 100 contains an example of an environment for executing at least some of the computer code involved in performing the inventive methods, such as optimal attribute derivation system 116. In addition to block 116, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 116, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically the computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 116 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 116 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth® connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi® signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi® network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

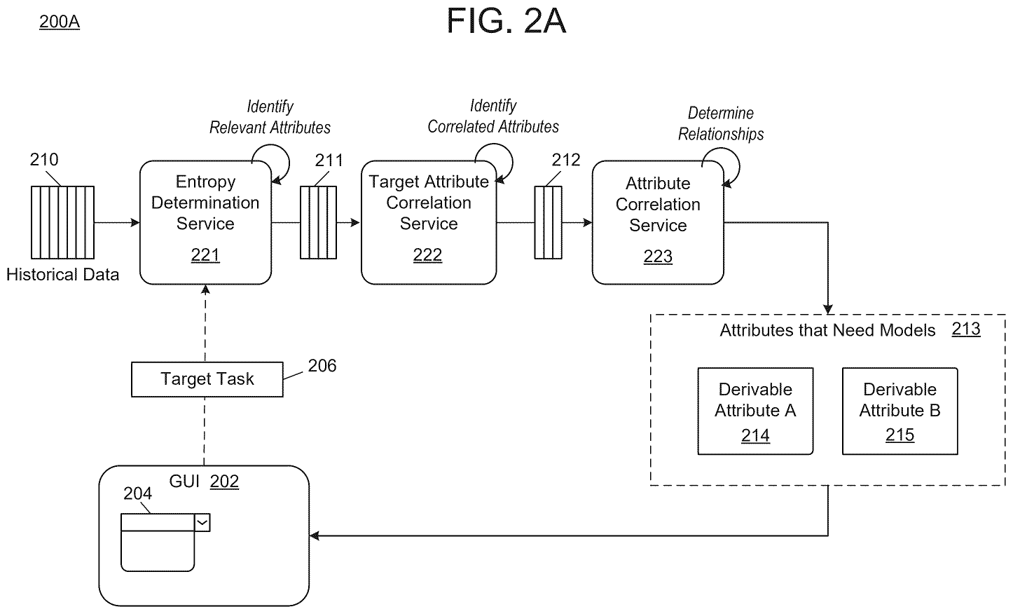

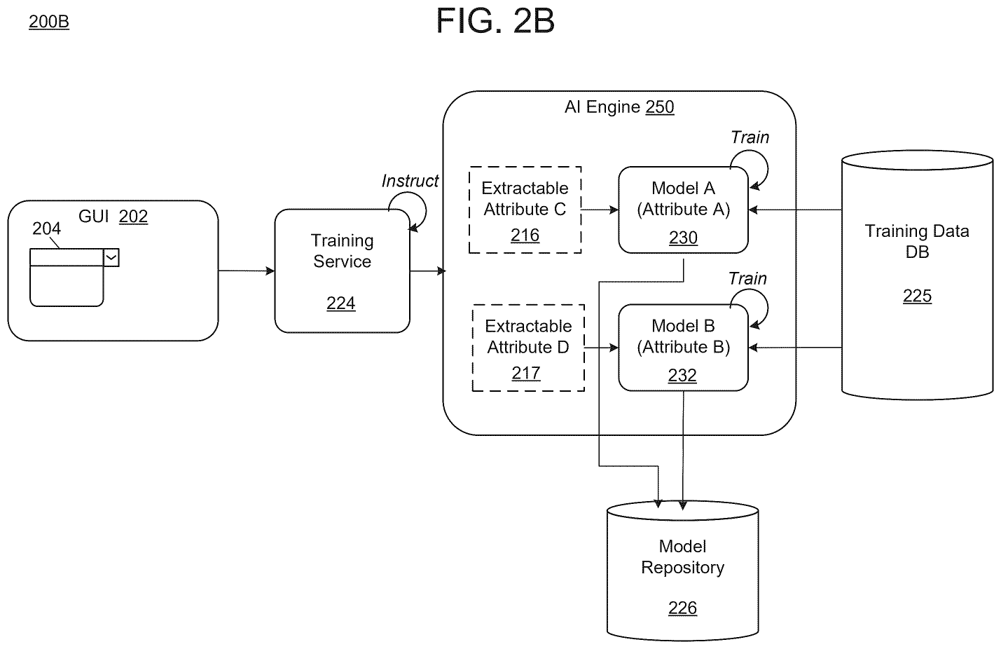

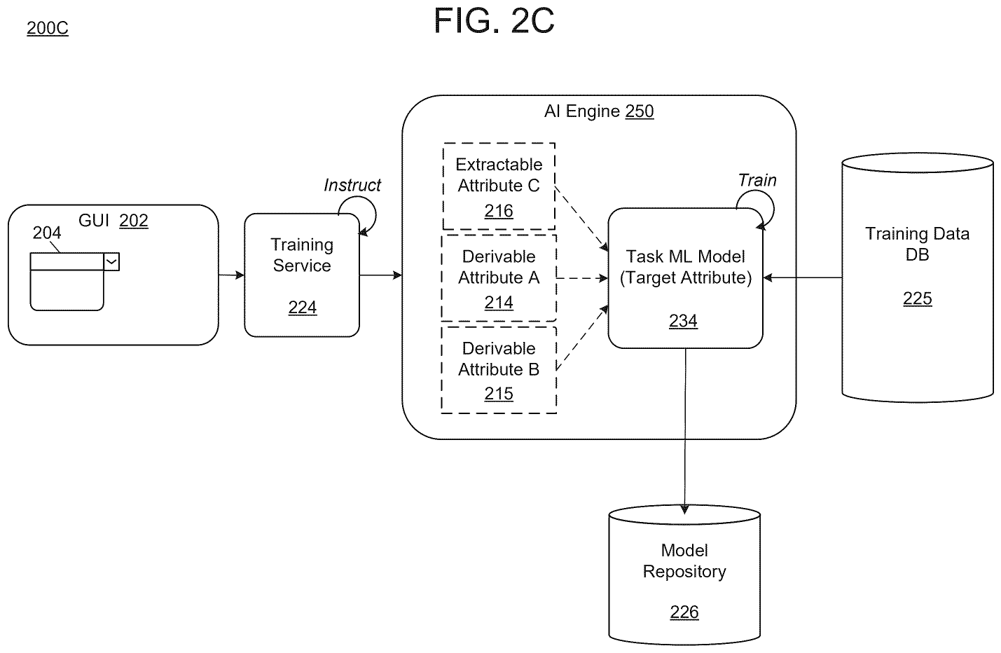

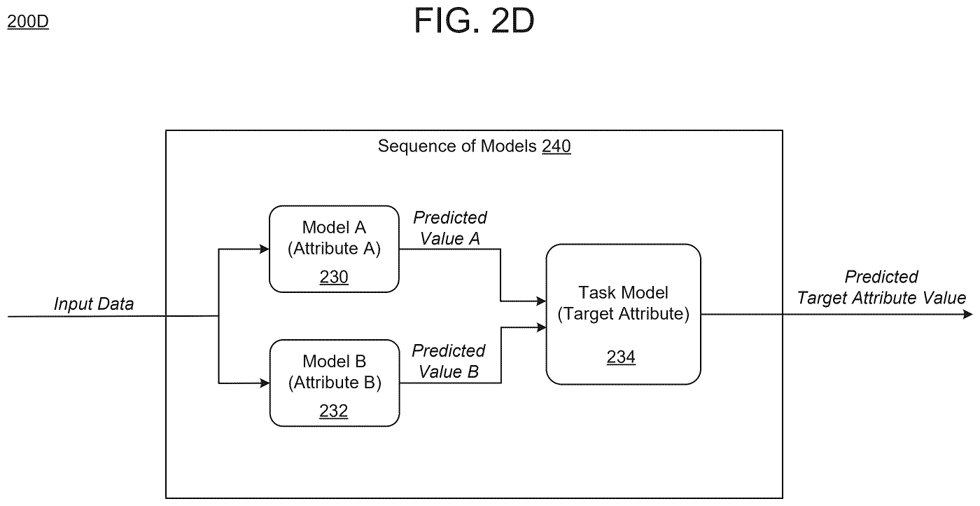

FIG. 2A illustrates a process 200A of identifying relevant candidate attributes that need predictive models from raw data according to the examples and features of the instant solution. For example, the process 200A may be performed to use raw historical data 210 to identify candidate attributes 214 and 215 from the raw historical data 210 that require predictive models.

For example, some of the relevant attributes to be used to predict the target attribute may be extractable directly from the historical data 210. However, some of the other relevant attributes may need to be predicted from the extractable attributes. These attributes are referred to as derivable attributes. The determination on which attributes need to be derived may be based on which attributes can be extracted from input data and which attributes are necessary for identifying a target attribute of a target task 206. One or more of the target task 206 and the target attribute may be input via GUI 202 using input mechanism 204, or the like. In some embodiments, the derivable attributes may be provided from the GUI 202 as well. As another example, the derivable attributes may be identified automatically based on at least one of the target task 206, the attributes necessary for identifying the target attribute, and the attributes available in the historical data 210, and the like. The process 200A may be performed by a software application executing on a host platform, such as a cloud platform, web server, distributed system, or the like.

Referring to FIG. 2A, the historical data 210 may include tabular data (e.g., rows and columns of data values) that includes both attribute data and target attribute data. For example, the historical data 210 may include a two-dimensional array of cells. Here, the array may include columns of data that refer to different attributes/values found in array. The attributes may refer to values that may be found in log files, tickets, system traces, resolutions, etc. associated with AIOps operations. For example, the attributes may include IP address, error message, block ID, error code, time, date, and many others. The different attributes may be stored in columns, and the rows may represent records with the values therein.

To start the process, a user may input a target task 206 (e.g., an identifier of a target attribute, an identifier of a model type for predicting the target attribute, attributes to be used to predict the target attribute, etc.) which may be used to generate an ML model for predicting the target attribute. The target task 206 may refer to a task for predicting a target attribute of an AIOps operation. For example, the task may include predicting a target attribute of one or more of an anomaly detection process, a fault localization process, a resolution retrieval process, an issue resolution process, and the like. The target task 206, model type to be used, etc., may be input through a graphical user interface 202 of the software application. Here, a user may select the task from the input mechanism 204 such as a drop-down menu, etc.

In the example of FIG. 2A, an entropy determination service 221 may receive the historical data 210 and may determine an entropy of each of the attributes (columns) within the historical data 210. For example, the entropy determination service 221 may identify a degree of randomness within the content values of a column (that corresponds to a candidate attribute) and determine an entropy value for the column based on the degree of randomness.

The entropy determination service 221 may execute an entropy function from a software library such as SciPy on each of the columns of candidate attributes to determine entropy values for the candidate attributes. Using the entropy computations, the entropy determination service 221 may identify a subset of attributes 211 (subset of columns) in the historical data 210 which are relevant to the target attribute based on the entropy values of the subset of attributes 211 being within a predetermined range of entropy values. The range of entropy values may include an upper threshold value (e.g., 5, 7, 10, etc.) and a lower threshold value (e.g., 1, 2, 3, etc.). While some randomness is good, zero randomness is not good for model training. Likewise, too much randomness is not good for model training. The use of the range of entropy values/thresholds identifies the columns of data with some randomness, but not too much randomness.

A target attribute correlation service 222 may determine a correlation among the subset of attributes 211 with respect to a target attribute based on execution of a correlation function on the subset of attributes 211 (columns) and the target attribute (column). In this case, the target attribute may be stored in the historical data 210 and may be identified from the GUI 202, etc. The target attribute correlation service 222 may identify an interdependence value between the subset of attributes and the target attribute. Thus, each column in the subset of columns corresponding to the subset of attributes 211 may receive a correlation value. The target attribute correlation service 222 may use the correlation values to remove any attributes (columns) with correlation values below a threshold to further refine the subset of attribute values down to a smaller subset of attributes 212.

An attribute correlation service 223 may identify one or more predictable attributes that are not expressly included in the attributes extracted from the historical data 210 but which can be predicted from the extracted attributes. This identification may be based on the type of model selected by the user via the GUI, the type of task to be performed, etc. The predictable attributes may have a relationship with one or more of the extractable attributes including an independent relationship, a conditional relationship, a hierarchical relationship, etc. The missing attributes may be referred to as “derivable” attributes which can be determined from the attributes extracted from the input data/historical data. The derivable attributes may require an extra model to predict the values thereof.

FIG. 2B illustrates a process of training ML models for predicting the relevant candidate attributes according to the examples and features of the instant solution. The derivable attributes 214 and 215 determined in the process of FIG. 2A may be displayed on the GUI 202 enabling a user to understand which models to create to predict the derivable attributes 214 and 215, and which extractable attributes to use to predict the derivable attributes 214 and 215. Referring to FIG. 2B, the user may input commands to select models including a ML model 230 for deriving the derivable attribute 214, and a ML model 232 for deriving the derivable attribute 215. In this case, the derivable attribute 214 may be derived from an extractable attribute 216 that is available and directly extractable from the input data. Meanwhile, the derivable attribute 215 may be derived from an extractable attribute 217 that is available and extractable from the input data.

Here, the user may enter commands via the GUI 202 to select the models including the ML model 230 and the ML model 232, and to select training data stored in a training data database 225 or training the ML model 230 and the ML model 232. For example, the user may enter commands via the GUI 202 to control a training service 224 that instructs an AI engine 250 to iteratively execute the ML model 230 on training data from the training data database 225, and to execute the ML model 232 on training data from the training database 225. Here, the training may train the ML model 230 to predict a value of the derivable attribute 214 based on a value of the extractable attribute 216. Likewise, the training may train the ML model 232 to predict a value of the derivable attribute 215 from a value of the extractable attribute 217. The trained models may be included in a sequence of models that are needed for predicting a target attribute from the derivable attribute 214, the derivable attribute 215, and possibly one or more extractable attributes that can be directly extracted from the input data. In some embodiments, values of the historical data 210 that were analyzed in the process of FIG. 2A are used as at least part of the training data used to train the ML models 230, 232. For example, pairs of target values and target value-affecting values from the historical data 210 are stored in the training data database 225 as part of the training data that is available to access and use for model training.

In some embodiments, the process of FIG. 2B occurs in a fully automated manner without any additional input being required by a user (other than the task having been selected as part of the process of FIG. 2A). Thus, instead of a user providing a model selection and/or training data selection via the GUI 202 as part of the process of FIG. 2B, a machine learning model is used that has been trained on model selection and training data selection based on data relationships. For example, this ML model is trained to identify appropriate ML model types and training data types to select in response to certain relationships such as one or more independent relationships, conditional relationships, hierarchical relationships, etc. being identified amongst the relevant historical data. This model receives, as input, the relationships of the data that were identified in the process of FIG. 2A, and, in response, this model produces as output an appropriate model type to train and appropriate training data to use for the training. In some embodiments, this model produces a few suggestions which narrows a total number of available models and training data and presents the suggestions for selection by the user.

FIG. 2C illustrates a process of training a ML model to determine a target attribute based on relevant candidate attributes according to the examples and features of the instant solution. Referring to FIG. 2C, the AI engine 250 may also be used to train a task-based ML model 234 to predict a target attribute based on the derivable attribute 214, the derivable attribute 215, and the extractable attribute 216. In this example, the type of model to use, the training data to use, and the like, may be input from a GUI 202 and provided to the training service 224. In response, the training service 224 may manage the AI engine 250 to execute the task-based ML model 234 to train the task-based ML model 234 to predict the target attribute based on the derivable attribute 214, the derivable attribute 215, and the extractable attribute 216.

The training process may include iteratively executing the task-based ML model 234 on training data that includes the relevant attributes and the target attribute, thereby causing the task-based ML model 234 to learn how to predict a value for the target attribute when provided values for the relevant attributes (e.g., the derivable attribute 214, the derivable attribute 215, and the extractable attribute 216).

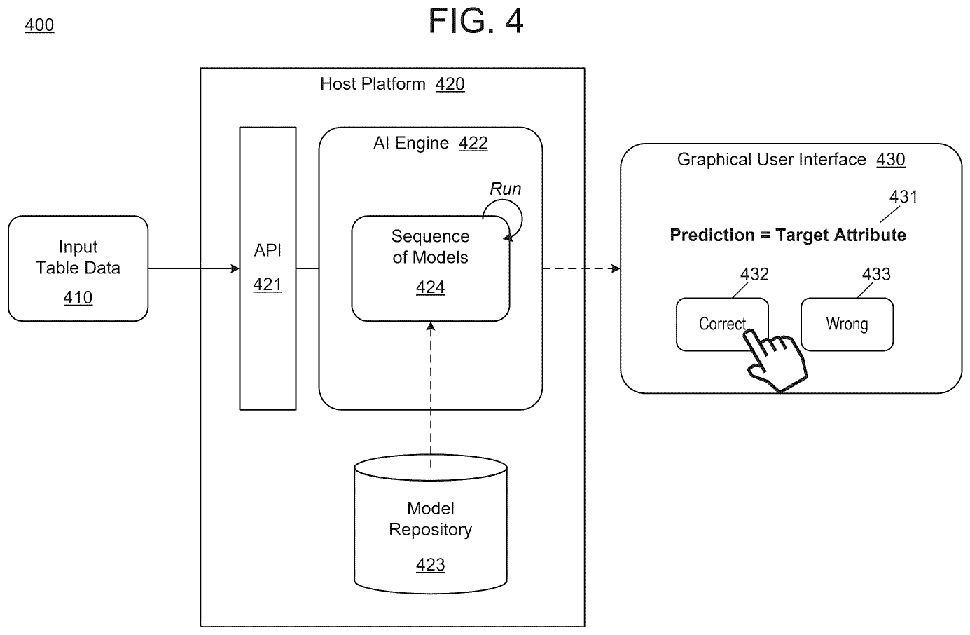

FIG. 2D illustrates a process 200D of generating a sequence of models 240 that can be generated according to the examples and features of the instant solution. Referring to FIG. 2D, the example embodiments provide services that may be used to generate the sequence of models 240 to predict the target attribute. In this example, the ML model 230 may be used to predict an input value (a value of the derivable attribute 214) that is used by the task-based ML model 234 to predict a value of the target attribute. Likewise, the ML model 232 may be used to predict an input value (value of derivable attribute 215) that is used by the task-based ML model 234 to predict a value of the target attribute. Here, the user may enter commands via the GUI 202 to provide an order to the sequence of models 240 including directing an output from the ML model 230 and the ML model 232 to the input of the task-based ML model 234. The resulting sequence of models 240 may be stored as an executable sequence of models (e.g., a model ensemble) within a model repository and used to predict a value of the target attribute from input data. An example of such an inference process is shown and described herein with respect to FIG. 4.

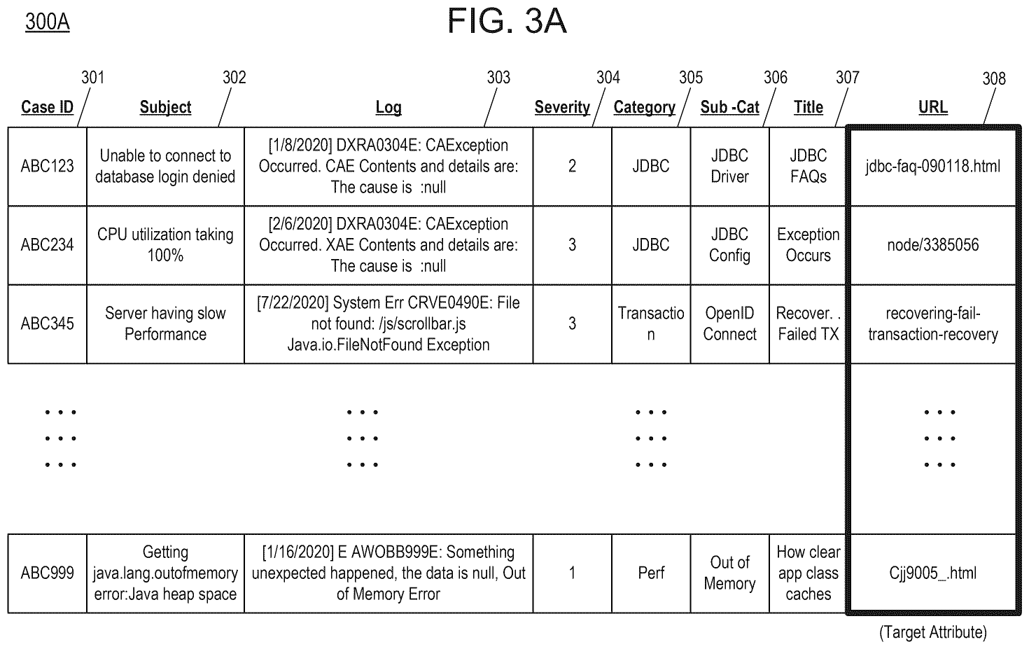

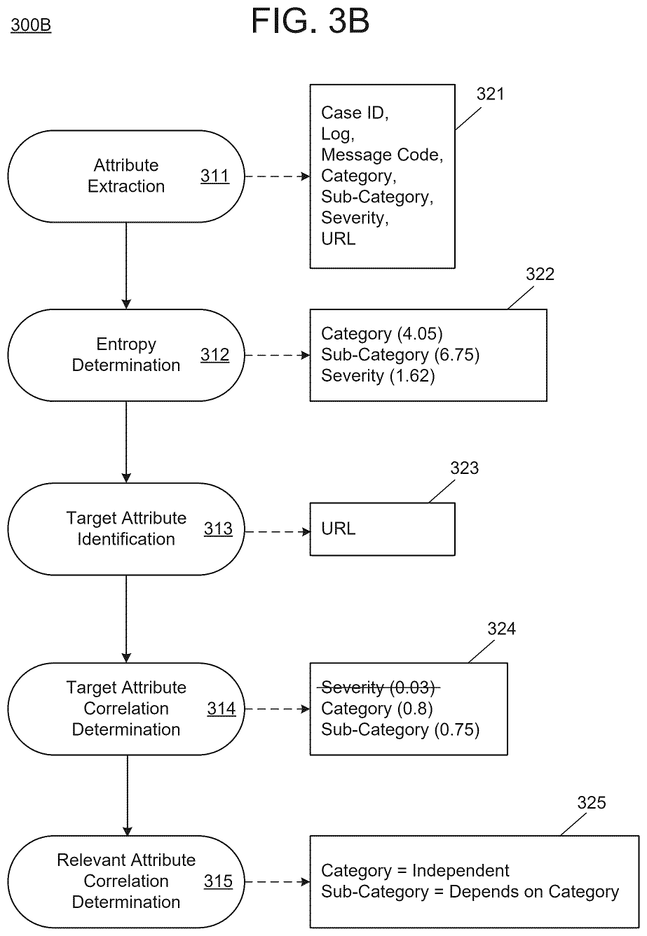

FIG. 3A illustrates a view 300A of attribute data stored in a table according to the examples and features of the instant solution, and FIG. 3B illustrates a process 300B of identifying attributes for model generation from the attribute data in FIG. 3A, according to the examples and features of the instant solution. Referring to FIG. 3A, the table includes eight columns of data corresponding to eight different attributes. The eight attributes are related to an issue resolution process commonly used in AIOps tasks. Here, the eight attributes include a case identifier of an issue, a subject of the issue, a log line describe the issue, a severity of the issue, a category of the issue, a sub-category of the issue, a title of the issue, and a URL where the resolution of the issue can be found.

In this example, a user may enter an identifier of a target attribute 308 via a graphical user interface. The task, in this case, is to generate a sequence of models that can predict a value of the target attribute given one or more of the relevant attributes associated with the target attribute. In this example, the table also includes candidate attributes 301, 302, 303, 304, 305, 306, and 307. Some of the candidate attributes may be used for the purpose of identifying the target attribute 308, while others may not. The process described herein may be used to identify which candidate attributes to use for building a model to predict the target attribute 308.

Referring now to FIG. 3B, the example embodiments may execute a software application to perform the services/microservices described herein. In this example, the software may perform a process that includes attribute extraction in 311, entropy determination in 312, target attribute identification in 313, target attribute correlation determination in 314, and relevant attribute correlation determination in 315. The result of the process may be an identifier of attributes that need a model, such as an ML model for predicting the attributes.

For example, the attribute extraction in 311 may extract some or all of the columns of data from the table shown in FIG. 3A. Here, the columns include the eight columns corresponding to the eight attributes 321 related to issue resolution including the case identifier of an issue, the subject of the issue, the log line describing the issue, the severity of the issue, the category of the issue, the sub-category of the issue, the title of the issue, and the URL where the resolution of the issue can be found. In 312, the entropy determination process determines the entropy values of all of the attributes, and identifies three attributes 322 (subset of attributes) including category, sub-category, and severity which have entropy values within a predefined range of entropy values (e.g., between 1-9). The entropy determination process is described with respect to FIG. 2B.

In 313, a target attribute 323 is identified. In this example, the target attribute is the URL of the issue resolution corresponding to column 308 in the table of FIG. 3A. The target attribute may be provided based on a user input via a GUI. Here, the user input may identify the target attribute or identify a task to be performed by a desired ML model, from which the target attribute may be inferred. In 314, a correlation process may be performed on the subset of attributes from 312 with respect to the target attribute from 313. The correlation process may be used to determine a correlation between the target attribute and each of the respective candidate attributes in the subset 322. The correlation process may compare the correlation value of each attribute with respect to a threshold (e.g., 0.5, 0.6, 0.7, etc.) Here, the correlation process results in the severity attribute being removed from the subset because its correlation value of 0.03 is below the threshold resulting in a reduced subset of attributes 324.

In 315, the relevant attribute correlation determination process 315 may be performed to identify a correlation between each of the attribute pairs in the reduced subset of attribute 324. Here, the relevant attribute correlation determination process 315 determines that the category attribute is an independent attribute that is not dependent on any of the other attributes. Meanwhile, the sub-category attribute is dependent on/conditional based on the category attribute. Here, two different models can be suggested for predicting the category attribute and the sub-category attribute based on the correlation determination. The suggested attributes can be displayed on the GUI, and the user can select the models to use, and the training data to use to train such models. The trained models may be integrated into a sequence of models that also includes a ML model for predicting a target attribute.

FIG. 4 illustrates a process 400 of executing a trained sequence of models to predict and target attribute and receiving feedback about the predicted result according to examples and features of the instant solution. In the examples herein, the at least one ML model (or AI model) may be a sequence of ML models. For example, one or more of the ML models may be configured to predict candidate attribute values, and a final ML model in the sequence may be configured to predict a target attribute value from the predicted candidate attribute values. Thus, a sequence of ML models, or model ensemble, may be used. Referring to FIG. 4, a host platform 420, such as a cloud platform, web server, or the like, may host an AI engine 422 for executing predictive models in a productive environment. The AI engine 422 may include an application programming interface (AP) 421 that may receive calls from a software application or other program. In some embodiments, an API call may include input data 402 along with an identifier of a model to be executed on the input data 402.

In the example of FIG. 4, the AI engine 422 receives a call with the input table data 410 through the API 421 of the AI engine 422, and in response, identifies a sequence of machine learning (ML) models 424 to be executed. For example, the sequence of ML models 424 may be the sequence of ML models 240 shown in the example of FIG. 2D, however, embodiments are not limited thereto and many different types of sequences of ML models may be used. Here, the AI engine 422 retrieves the sequence of ML models 424 from a model repository 423, and executes the sequence of ML models 424 on the input table data 410 to generate a predictive result (i.e. to predict a target attribute value). In response, the AI engine 422 may display an identifier 431 of the target attribute value predicted by the sequence of ML models 424 on a graphical user interface (GUI) 430. The GUI 430 may correspond to a GUI of a software application which submitted the API call. As another example, the GUI 430 may correspond to a GUI of another software system.

In some embodiments, the sequence of ML models 424 also includes the performance of a task such as an AIOps task in response to the values of the predictive result. For example, in some embodiments the task is selected from a group consisting of at least one of issue resolution, anomaly detection, event correlation, and capacity optimization. The sequence of ML models 424 generates instructions that are transmitted that cause one or more other components to perform an action as a part of the issue resolution, anomaly detection, event correlation, and/or capacity optimization. In some embodiments, additional training of a ML model that is part of the sequence of ML models 424 is performed using task training data with supervised training data that includes historical values of the target values paired with respective appropriate actions to initiate in response to certain values, e.g., certain ranges of those values, being met.

In addition to displaying the identifier 431 of the predictive result, the AI engine 422 may also display GUI elements 432 and 433 which provide input mechanisms through which a user can provide feedback about the predictive result. Here, the GUI elements 432 and 433 may correspond to a button, tab, etc. which the user can provide input through to indicate whether or not the predictive result is accurate/correct. In either case, both the predictive result and the feedback from the user via the GUI 430 may be used to retrain one or more ML models in the sequence of ML models 424. For example, the sequence of ML models 424 may be retrained by executing the sequence of ML models 424 on the predicted target attribute value, the indication of whether the predictive result is correct or incorrect, and the like.

Detailed descriptions of training a machine learning model and executing a machine learning model are further described and depicted herein.

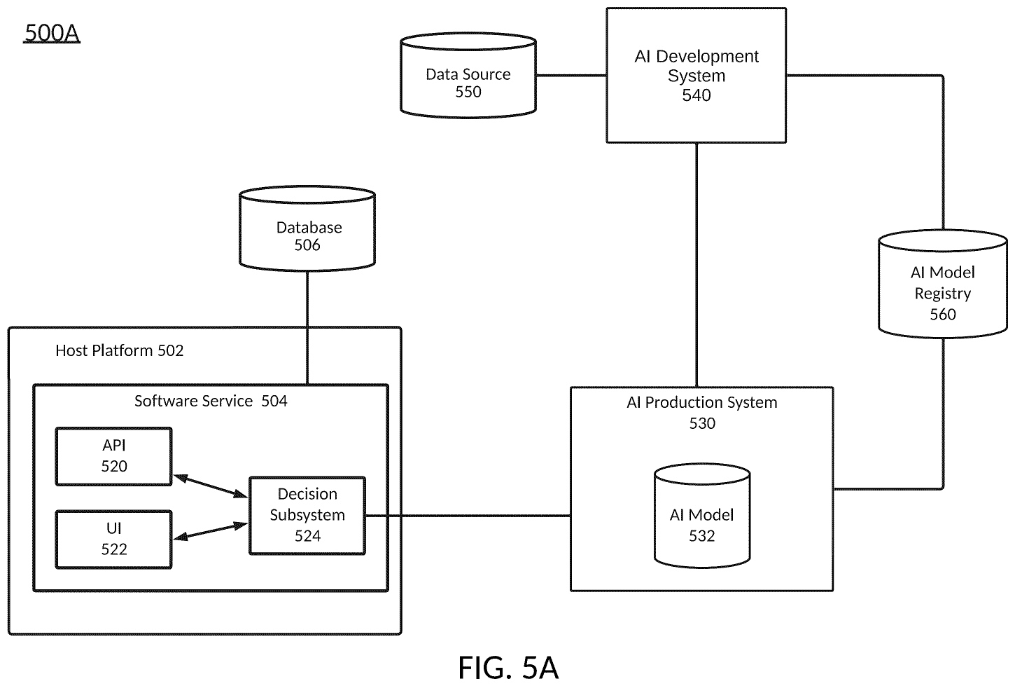

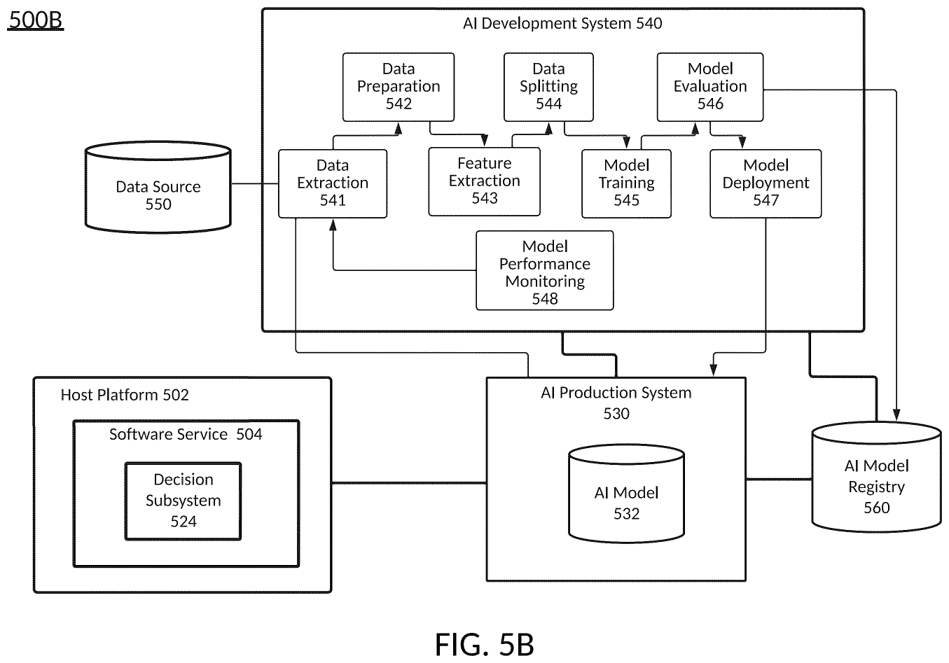

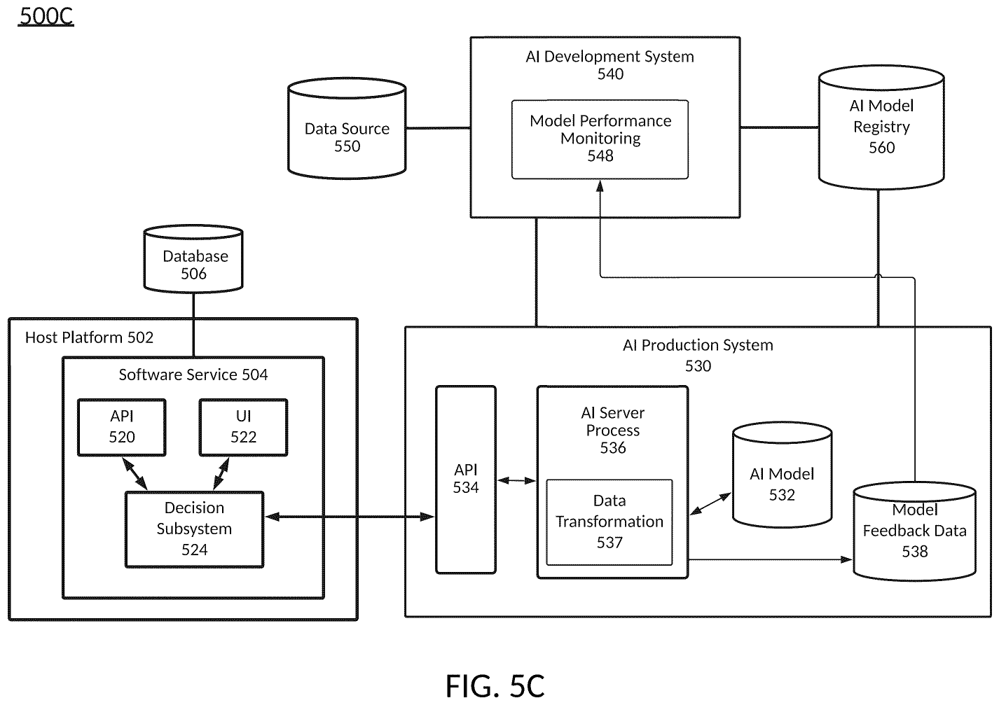

FIG. 5A illustrates an artificial intelligence (AI) network diagram 500A that supports AI-assisted decision points in a software service executing on a computer. As one example, the AI model being trained in the examples herein may refer to an AI model for AIOps tasks such as fault localization, anomaly detection, resolution retrieval, and many others. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 504 (see FIG. 5A), executing on host platform 502 (see FIG. 5A) may provide one or more application programming interfaces (APIs) 520 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more decision subsystems 524 of the software service 504 to assist in decision-making. In some examples and features of the instant solution, the software service 504 stores data included in API requests or data generated during processing the API requests into one or more databases 506 (see FIG. 5A).

Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud-hosted. In some examples and features of the instant solution, the AI production system 530 is deployed in a distributed multi-node architecture.

An AI development system 540 creates one or more AI models 532. In some examples and features of the instant solution, the AI development system 540 utilizes data from one or more data sources 550 (such as the relevant attributes and the interdependent identified among the relevant attributes shown in the examples of FIGS. 2A-2C) to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 is cloud-hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more data sources 550. In some examples and features of the instant solution, historical model feedback data is extracted from one or more AI production systems 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results.

The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

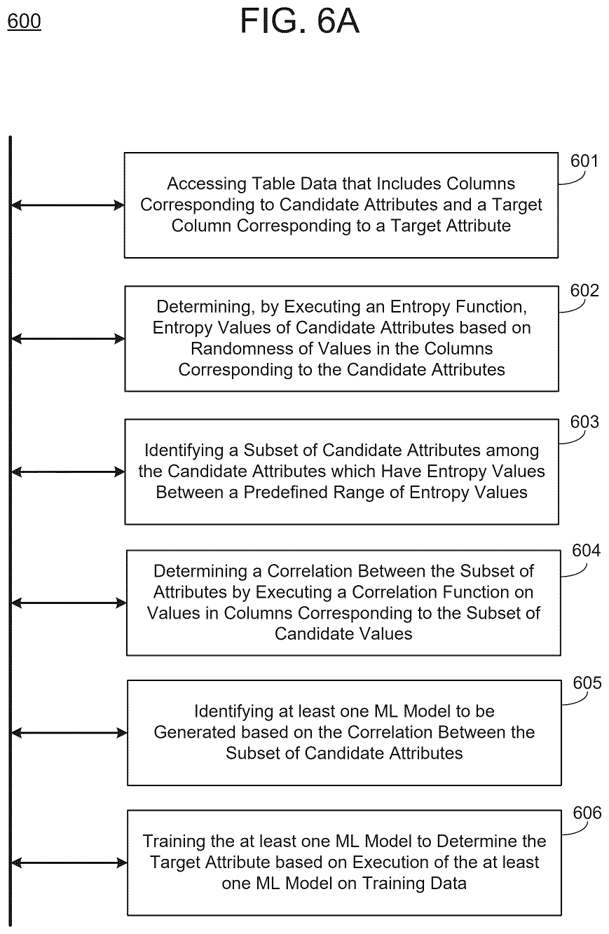

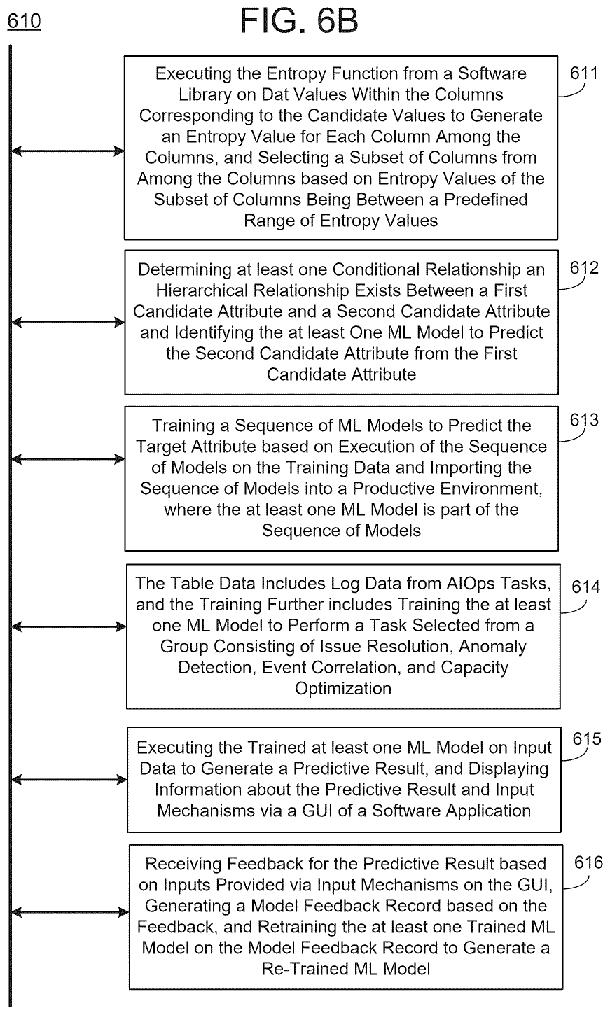

FIG. 6A illustrates a flow diagram of a method 500, according to example embodiments. Referring to FIG. 6A, the method 600 may include accessing table data within a database, the table data may include columns corresponding to candidate attributes, respectively, and a target column corresponding to a target attribute in 601. In 602, the method may include determining, by executing an entropy function, entropy values of the candidate attributes based on randomness of values in the columns corresponding to the candidate attributes, respectively. In 603, the method may include identifying a subset of candidate attributes among the candidate attributes that have entropy values between a predefined range of entropy values. In 604, the method may include determining a correlation between the subset of attributes by executing a correlation function on values in columns corresponding to the subset of candidate attributes. In 605, the method may include identifying at least one machine learning (ML) model to be generated based on the correlation between the subset of candidate attributes. In 606, the method may include training the at least one ML model to determine the target attribute based on execution of the at least one ML model on training data to generate a trained at least one ML model.

FIG. 6B illustrates a flow diagram of a method 610, according to example embodiments. Referring to FIG. 6B, in 611, the method may include executing the entropy function from a software library on data values within the columns corresponding to the candidate attributes to generate an entropy value for each column among the columns, and selecting a subset of columns from among the columns based on entropy values of the subset of columns being between the predefined range of entropy values. In 612, the method may include determining at least one of a conditional relationship and a hierarchical relationship exists between a first candidate attribute and a second candidate attribute, and generating a model to predict the second candidate attribute from the first candidate attribute. In 613, the method may further include training a sequence of ML models to predict the target attribute based on execution of the sequence of ML models on the training data, and importing the sequence of ML models into a productive environment, wherein the at least one ML model is part of the sequence of ML models.

In 614, the table data may include log data from Artificial Intelligence for IT Operations (AIOps) tasks, and the method may further include training the at least one ML model to perform a task that is selected from a group consisting of issue resolution, anomaly detection, event correlation, and capacity optimization. In 615, the method may further include executing the trained at least one ML model on input data to generate a predictive result, and displaying information about the predictive result and input mechanisms via a graphical user interface (GUI) of a software application. In 616, the method may further include receiving feedback about the predictive result based on inputs provided via the input mechanisms of the GUI, generating a model feedback record based on the feedback, and retraining the at least one ML model based on the model feedback record to generate a re-trained ML model.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A computer-implemented method comprising:
accessing table data within a database, the table data comprising columns corresponding to candidate attributes, respectively, and a target column corresponding to a target attribute;
determining, by executing an entropy function, entropy values of the candidate attributes based on randomness of values in the columns corresponding to the candidate attributes, respectively;
identifying a subset of candidate attributes among the candidate attributes which have entropy values between a predefined range of entropy values;
determining a correlation between the subset of attributes by executing a correlation function on values in columns corresponding to the subset of candidate attributes;
identifying at least one machine learning (ML) model to be generated based on the correlation between the subset of candidate attributes; and
training the at least one ML model to determine the target attribute based on execution of the at least one ML model on training data to generate a trained at least one ML model.

2. The computer-implemented method of claim 1, wherein the determining the entropy values comprises executing the entropy function from a software library on data values within the columns corresponding to the candidate attributes to generate an entropy value for each column among the columns, and the identifying comprises selecting a subset of columns from among the columns based on entropy values of the subset of columns being between the predefined range of entropy values.

3. The computer-implemented method of claim 1, wherein the determining the correlation comprises determining at least one of a conditional relationship and a hierarchical relationship exists between a first candidate attribute and a second candidate attribute, and the identifying at least one ML model comprises identifying an ML model to predict the second candidate attribute from the first candidate attribute.

4. The computer-implemented method of claim 1, further comprising training a sequence of ML models to predict the target attribute based on execution of the sequence of ML models on the training data, and importing the sequence of ML models into a productive environment, wherein the at least one ML model is part of the sequence of ML models.

5. The computer-implemented method of claim 1, wherein the table data comprises log data from Artificial Intelligence for IT Operations (AIOps) tasks, and the training further comprises training the at least one ML model to perform a task that is selected from a group consisting of issue resolution, anomaly detection, event correlation, and capacity optimization.

6. The computer-implemented method of claim 1, further comprising executing the trained at least one ML model on input data to generate a predictive result, and displaying information about the predictive result and input mechanisms via a graphical user interface (GUI) of a software application.

7. The computer-implemented method of claim 6, further comprising receiving feedback about the predictive result based on inputs provided via the input mechanisms of the GUI, generating a model feedback record based on the feedback, and retraining the at least one ML model based on the model feedback record to generate a re-trained ML model.

8. A computer system comprising:
a processor set;
a set of one or more computer-readable storage media; and
program instructions, collectively stored in the set of one or more storage media, for causing the processor set to perform computer operations comprising:
accessing table data within a database, the table data comprising columns corresponding to candidate attributes, respectively, and a target column corresponding to a target attribute;
determining, by executing an entropy function, entropy values of the candidate attributes based on randomness of values in the columns corresponding to the candidate attributes, respectively;
identifying a subset of candidate attributes among the candidate attributes which have entropy values between a predefined range of entropy values;
determining a correlation between the subset of attributes by executing a correlation function on values in columns corresponding to the subset of candidate attributes;
identifying at least one machine learning (ML) model to be generated based on the correlation between the subset of candidate attributes; and
training the at least one ML model to determine the target attribute based on execution of the at least one ML model on training data to generate a trained at least one ML model.

9. The computer system of claim 8, wherein the determining the entropy values comprises executing the entropy function from a software library on data values within the columns corresponding to the candidate attributes to generate an entropy value for each column among the columns, and the identifying comprises selecting a subset of columns from among the columns based on entropy values of the subset of columns being between the predefined range of entropy values.

10. The computer system of claim 8, wherein the determining the correlation comprises determining at least one of a conditional relationship and a hierarchical relationship exists between a first candidate attribute and a second candidate attribute, and the identifying at least one ML model comprises identifying an ML model to predict the second candidate attribute from the first candidate attribute.

11. The computer system of claim 8, wherein the computer operations further comprise training a sequence of ML models to predict the target attribute based on execution of the sequence of ML models on the training data, and importing the sequence of ML models into a productive environment, wherein the at least one ML model is part of the sequence of ML models.

12. The computer system of claim 8, wherein the table data comprises log data from Artificial Intelligence for IT Operations (AIOps) tasks, and the training further comprises training the at least one ML model to perform a task that is selected from a group consisting of issue resolution, anomaly detection, event correlation, and capacity optimization.

13. The computer system of claim 8, wherein the computer operations further comprise executing the trained at least one ML model on input data to generate a predictive result, and displaying information about the predictive result and input mechanisms via a graphical user interface (GUI) of a software application.

14. The computer system of claim 13, wherein the computer operations further comprise receiving feedback about the predictive result based on inputs provided via the input mechanisms of the GUI, generating a model feedback record based on the feedback, and retraining the at least one ML model based on the model feedback record to generate a re-trained ML model.

15. A computer program product comprising:
a set of one or more computer-readable storage media; and
program instructions, collectively stored in the set of one or more computer-readable storage media, for causing a processor set to perform computer operations comprising:
accessing table data within a database, the table data comprising columns corresponding to candidate attributes, respectively, and a target column corresponding to a target attribute;
determining, by executing an entropy function, entropy values of the candidate attributes based on randomness of values in the columns corresponding to the candidate attributes, respectively;
identifying a subset of candidate attributes among the candidate attributes which have entropy values between a predefined range of entropy values;
determining a correlation between the subset of attributes by executing a correlation function on values in columns corresponding to the subset of candidate attributes;
identifying at least one machine learning (ML) model to be generated based on the correlation between the subset of candidate attributes; and
training the at least one ML model to determine the target attribute based on execution of the at least one ML model on training data to generate a trained at least one ML model.

16. The computer program product of claim 15, wherein the determining the entropy values comprises executing the entropy function from a software library on data values within the columns corresponding to the candidate attributes to generate an entropy value for each column among the columns, and the identifying comprises selecting a subset of columns from among the columns based on entropy values of the subset of columns being between the predefined range of entropy values.

17. The computer program product of claim 15, wherein the determining the correlation comprises determining at least one of a conditional relationship and a hierarchical relationship exists between a first candidate attribute and a second candidate attribute, and the identifying at least one ML model comprises identifying an ML model to predict the second candidate attribute from the first candidate attribute.

18. The computer program product of claim 15, wherein the computer operations further comprise training a sequence of ML models to predict the target attribute based on execution of the sequence of ML models on the training data, and importing the sequence of ML models into a productive environment, wherein the at least one ML model is part of the sequence of ML models.

19. The computer program product of claim 15, wherein the table data comprises log data from Artificial Intelligence for IT Operations (AIOps) tasks, and the training further comprises training the at least one ML model to perform a task that is selected from a group consisting of issue resolution, anomaly detection, event correlation, and capacity optimization.

20. The computer program product of claim 15, wherein the computer operations further comprise executing the trained at least one ML model on input data to generate a predictive result, and displaying information about the predictive result and input mechanisms via a graphical user interface (GUI) of a software application.
